(19) United States
(12) Patent Application Publication
(10) Pub. No.: US 2026/0316619 A1
(43) Pub. Date: Oct. 15, 2026

(54) OPERATING METHOD FOR AN ELECTRIC VEHICLE WITH A RANGE EXTENDER

(71) Applicant: AUDI AG, Ingolstadt (DE)

(72) Inventors: Paul BÖCKENHOFF, Ingolstadt (DE); Alexander GUMMER, Ingolstadt (DE)

(21) Appl. No.: 19/464,252

(22) Filed: Jan. 29, 2026

(30) Foreign Application Priority Data
Jan. 30, 2025 (DE) 102025103376.5

(51) Int. Cl. B60L 53/66; B60H 1/00; B60L 1/02; B60L 53/50; B60L 58/12; H02J 7/14; B60H 1/02

(52) U.S. Cl. CPC B60L 53/665; B60H 1/00278; B60L 1/02; B60L 53/50; B60L 58/12; H02J 7/14; B60H 1/02; B60L 2240/662

(57) ABSTRACT

A method for operating an electric vehicle. According to the method, a control unit of an electric vehicle activates a range extender, REX, of the electric vehicle during a trip of the electric vehicle as a function of a determined current state of charge, SoC, of a high-voltage battery, HVB, of the electric vehicle, a determined current and/or predicted electrical energy demand of the electric vehicle, and a determined current and/or predicted thermal energy demand of the electric vehicle. An electric current provided by an electric generator of the REX charges the HVB, and waste heat of the REX provided by a heat exchanger of the REX maintains the temperature of the electric vehicle.

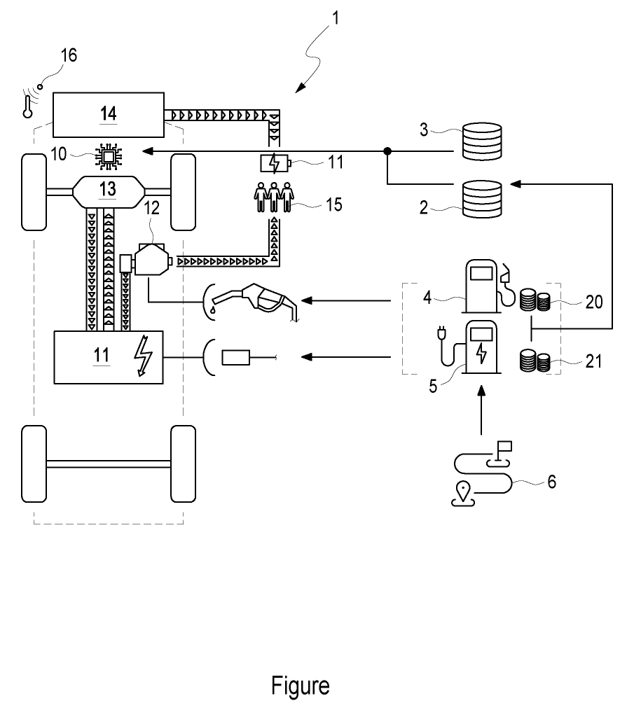

### BACKGROUND

### Technical Field

The disclosure relates to a method for operating an electric vehicle, in which a control unit of an electric vehicle activates a range extender, REX, of the electric vehicle during a trip of the electric vehicle, depending on a determined current state of charge, SoC, of a high-voltage battery, HVB, of the electric vehicle, a determined current and predicted electrical energy demand of the electric vehicle, and a determined current and predicted thermal energy demand of the electric vehicle; and an electric current provided by an electric generator of the REX charges the HVB, and waste heat of the REX provided by a heat exchanger of the REX regulates the temperature of the electric vehicle. The disclosure further relates to a control unit for an electric vehicle and to an electric vehicle.

### Description of the Related Art

Methods of the type mentioned at the beginning, referred to in short as operating methods, are part of the prior art in various configurations and serve to increase the driving range of the electric vehicle. For the purposes of the disclosure, an electric vehicle is to be understood as a vehicle driven exclusively by an electric motor, i.e., a so-called battery electric vehicle, BEV. Accordingly, the electric vehicle comprises an electric drive motor, referred to in short as an electric motor, and a high-voltage battery, HVB, which may also be referred to as a traction battery.

The REX comprises a fuel tank, an internal combustion engine fluidly connected to the fuel tank, and an electric generator rotationally coupled to an output shaft of the internal combustion engine. In a first stage, the internal combustion engine burns a fuel supplied from the fuel tank and, as a result of the combustion, provides a torque to drive the electric generator by way of the output shaft. In a second stage, the driven electric generator converts rotational energy into an electric current. The electric current provided by the generator is stored as electrical energy in the HVB. A battery electric vehicle with a REX is also called an Electric Range Extender Vehicle, EREV.

However, due to the low efficiency of the first stage, which is generally between 25% and 40%, and the overall two-stage conversion of energy stored in the fuel into electrical energy, the efficiency of the REX is low and, due to the low efficiency, is more suitable for extending the range in certain situations, i.e., to reach a charging station located outside the range without the REX. However, the REX does not significantly increase the overall efficiency of the electric vehicle, especially since the REX also increases the mass of the electric vehicle.

The low efficiency of the first stage results from the waste heat generated during the combustion of the fuel, i.e., thermal energy that cannot, in principle, be used to drive the generator, and thermal energy of the exhaust gas of the REX generated by the combustion of the fuel and emitted into the environment of the electric vehicle. Accordingly, the efficiency of the REX and thus the overall efficiency of the electric vehicle can be increased by utilizing the waste heat of the REX.

For example, CN 116101026 A discloses an operating method for an electric vehicle in which a REX of the electric vehicle is activated when a heat demand of an interior of the electric vehicle and/or of an HVB of the electric vehicle is detected, and a Positive Temperature Coefficient, PTC, heater of the electric vehicle is started ten seconds before deactivation of the REX.

Alternatively, CN 216424103 U discloses an operating method for an electric vehicle, in which a REX of the electric vehicle is started depending on the SoC of an HVB of the electric vehicle and depending on the temperature of the HVB.

An operating method for an electric vehicle is also known from CN 118560451 A, in which waste heat of a REX of the electric vehicle is used at least partially to cover a total heat demand of the electric vehicle, and respective electrical output powers of the REX and/or of an HVB of the electric vehicle are correspondingly reduced to cover a remaining part of the total heat demand.

### BRIEF SUMMARY

Embodiments of the disclosure provide a method for operating an EREV, i.e., an electric vehicle with a range extender, which increases the overall efficiency of the electric vehicle and improves the economic efficiency of the electric vehicle. Further objects of the disclosure are to provide a control unit for an electric vehicle and an electric vehicle.

One aspect of the disclosure is a method for operating an electric vehicle, in which a control unit of an electric vehicle activates a range extender, REX, of the electric vehicle during a trip of the electric vehicle depending on a determined current state of charge, SoC, of a high-voltage battery, HVB, of the electric vehicle, a determined current and/or predicted electrical energy demand of the electric vehicle, and a determined current and/or predicted thermal energy demand of the electric vehicle; and an electric current provided by an electric generator of the REX charges the HVB, and waste heat of the REX provided by a heat exchanger of the REX regulates the temperature of the electric vehicle. The control unit can determine the driving range of the electric vehicle without activating the REX from the current SoC and the current and/or predicted electrical energy demand. The electrical energy demand comprises both electrical drive energy and electrical energy to control the temperature of the electric vehicle, for example, to operate a positive temperature coefficient, PTC, heater of the electric vehicle.

On the one hand, the REX directly counteracts discharge of the HVB and, on the other hand, directly reduces electrical energy consumption for temperature control of the electric vehicle, which, in turn, indirectly counteracts discharge of the HVB. The operating method, therefore, increases the overall efficiency and thus the driving range of the electric vehicle.

According to the disclosure, the control unit determines a fuel price of a fuel provided by a fueling station arranged along a predicted driving route of the electric vehicle and/or an electricity price of an electric charging current provided by an electric charging station arranged along the predicted driving route, and the control unit additionally activates the REX depending on the determined fuel price and/or the determined electricity price. The electric vehicle uses fossil energy and electrical energy as primary energy sources, the supply of which varies along the route in terms of space and cost. Significant spatial and financial variations may result from national borders or technical circumstances. The control unit takes such variations into account flexibly, thereby improving the economic efficiency of the electric vehicle.

Advantageously, the control unit activates the REX later when the fuel price is higher than the electricity price. In this way, fuel is saved when the electric charging current is financially more favorable.

Conveniently, the control unit activates the REX earlier when the fuel price is lower than the electricity price. In this way, electric charging current is saved when fuel is cheaper.

In one embodiment, the determination of the fuel price and/or the electricity price comprises querying a price database. The price database may provide both fuel prices and electricity prices. Alternatively, the fuel prices and the electricity prices can each be provided by separate databases. The price database may be located externally in relation to the electric vehicle and queried via a wireless connection of the electric vehicle. Alternatively, the price database may be stored in the electric vehicle and updated regularly via a wireless connection of the electric vehicle.

For example, the temperature control of the electric vehicle comprises heating the interior of the electric vehicle and/or conditioning the HVB. The electric vehicle may comprise a climate control system to heat the interior. To condition the HVB, the electric vehicle may comprise a thermal management system of the electric vehicle assigned to the HVB or a thermal management system comprising the HVB, each with a heating/cooling circuit. Thermal energy for heating the interior and/or for conditioning the HVB may be provided by an electrically operated Positive Temperature Coefficient, PTC, heater of the electric vehicle, insofar as the waste heat of the REX is not used.

Preferably, the control unit also activates the REX depending on the current and/or predicted temperature of the ambient air of the electric vehicle during the trip. The temperature of the ambient air, or more precisely, the temperature difference between the temperature of the ambient air and the temperature of the interior or of the HVB, determines a demand for thermal energy for heating the interior or conditioning the HVB. In other words, the thermal energy demand is relative. Taking into account the relativity of the thermal energy demand further improves the overall efficiency and the economic efficiency of the electric vehicle.

In particular, an external sensor of the electric vehicle and/or a weather database may provide the temperature to the control unit. The price database may be located externally in relation to the electric vehicle and queried via a wireless connection of the electric vehicle.

The control unit may also advantageously activate the REX depending on the distance the electric vehicle is predicted to travel. The predicted route may comprise road categories, maximum speeds, traffic lights, traffic density, altitude profiles, and the suchlike, and therefore more precisely influences a variable consumption of electrical drive energy of the electric vehicle during the trip. Taking into account the variability of the electrical energy consumption further improves the overall efficiency and the economic efficiency of the electric vehicle.

Another aspect of the disclosure is a control unit for an electric vehicle. The control unit is used to operate a range extender, REX, of the electric vehicle and is designed to be functionally connected to the REX and to a high-voltage battery, HVB, of the electric vehicle.

According to the disclosure, the control unit is configured to carry out a method according to one embodiment of the disclosure for operating the electric vehicle. The operating method according to the disclosure serves to increase the overall efficiency of the electric vehicle and to improve the economic efficiency of the electric vehicle.

Another aspect of the disclosure is an electric vehicle comprising a high-voltage battery, HVB, and a range extender, REX, for charging the HVB while the electric vehicle is traveling. The electric vehicle comprises exclusively an electric drive motor, which is designed to be operated with electrical energy provided by the HVB.

According to the disclosure, the electric vehicle comprises a control unit functionally connected to the HVB and the REX, according to one embodiment of the disclosure. The control unit according to the disclosure increases the overall efficiency of the electric vehicle and improves the economic efficiency of the electric vehicle.

A substantial advantage of the method according to the disclosure is that the overall efficiency of the electric vehicle is significantly increased, and the economic efficiency of the electric vehicle is substantially improved. Apart from this, the method according to the disclosure integrates the REX more strongly into the operation of the electric vehicle, i.e., the REX is not used exclusively on a situational basis. Rather, the REX plays an important role within the energy flow concept of the electric vehicle, which means that the additional weight of the REX is better justified than in the case of a merely situational use, when a charging station is still to be reached despite insufficient stored electrical energy. Last but not least, the method according to the disclosure counteracts a range anxiety of a user of the electric vehicle or a dissatisfaction of the user with an insufficient driving range of the electric vehicle.

### BRIEF DESCRIPTION OF THE SEVERAL VIEWS OF THE DRAWINGS

The disclosure is schematically illustrated by way of an embodiment in the drawings and is described further with reference to the drawings. In the figures:

The Figure is a schematic representation of an electric vehicle according to one embodiment of the disclosure.

### DETAILED DESCRIPTION

The Figure shows a schematic representation of an electric vehicle 1 according to one embodiment of the disclosure. The electric vehicle 1 comprises a high-voltage battery, HVB, 11, and a range extender, REX, 12, for charging the HVB 11 while the electric vehicle 1 is in motion.

As is known, the electric vehicle 1 may also include an electric motor 13 for driving the electric vehicle 1, a PTC heater 14 for controlling the temperature of the electric vehicle 1, an interior 15 for accommodating occupants of the electric vehicle 1, and an exterior sensor 16 for detecting the temperature of the ambient air of the electric vehicle 1.

Furthermore, the electric vehicle 1 comprises a control unit 10 coupled to the HVB 11 and the REX 12 according to one embodiment of the disclosure. In one or more implementations, the control unit 10 is a controller having a microprocessor that includes a processor and a memory storing instructions that, when executed by the processor, cause the microprocessor to perform the acts of the control unit 10 described herein.

The control unit 10 is suitable for the electric vehicle 1 and is configured to carry out a method according to one embodiment of the disclosure as follows, in order to operate the electric vehicle 1.

The control unit 10 of the electric vehicle 1 activates the range extender, REX, 12 of the electric vehicle 1 during a trip of the electric vehicle 1 depending on a determined current state of charge, SoC, of the high-voltage battery, HVB, 11 of the electric vehicle 1, a determined current and/or predicted electrical energy demand of the electric vehicle 1 for the trip, and a determined current and/or predicted thermal energy demand of the electric vehicle 1 for the trip.

An electric current provided by an electric generator of the REX 12 charges the HVB 11, and waste heat from the REX 12, provided by a heat exchanger of the REX 12, regulates the temperature of the electric vehicle 1. The temperature control of the electric vehicle 1 may comprise heating the interior 15 of the electric vehicle 1 and/or conditioning the HVB 11.

The control unit 10 determines a fuel price 20 of a fuel provided by a fueling station 4 located along a predicted route 6 of the electric vehicle 1 and/or an electricity price 21 of an electric charging current provided by a charging station 5 located along the predicted route 6. Determining the fuel price 20 and/or the electricity price 21 may involve querying a price database 2.

The control unit 10 also activates the REX 12 depending on the determined fuel price 20 and/or the determined electricity price 21. Preferably, the control unit 10 activates the REX 12 later, when the fuel price 20 is higher than the electricity price 21, and/or the control unit 10 activates the REX 12 earlier, when the fuel price 20 is lower than the electricity price 21.

The control unit 10 may also activate the REX 12 depending on the current and/or predicted temperature of the ambient air of the electric vehicle 1 during the trip. For this purpose, an external sensor 16 of the electric vehicle 1 and/or a weather database 3 may provide the temperature to the control unit 10.

The control unit 10 may also activate the REX 12 depending on the predicted route 6 of the electric vehicle 1 for the trip.

German application no. 102025103376.5, filed Jan. 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of operating an electric vehicle, the method comprising:
activating, by a control unit of the electric vehicle, a range extender, REX, of the electric vehicle during a trip of the electric vehicle as a function of a determined current state of charge, SoC, of a high-voltage battery, HVB, of the electric vehicle, a determined current electrical energy demand of the electric vehicle and/or a predicted electrical energy demand of the electric vehicle for the trip, and a determined current thermal energy demand of the electric vehicle and/or a predicted thermal energy demand of the electric vehicle for the trip;
charging, by an electric current provided by an electric generator of the REX, the HVB;
controlling regulation of a temperature of the electric vehicle using waste heat of the REX provided by a heat exchanger of the REX; and
determining, by the control unit, a fuel price of a fuel provided by a fueling station arranged along a predicted route of the electric vehicle and/or an electricity price of an electric charging current provided by a charging station arranged along the predicted route and
wherein the activating of the REX is based on the fuel price and/or the electricity price determined by the control unit.

2. The method according to claim 1, wherein the control unit activates the REX later, when the fuel price is higher than the electricity price.

3. The method according to claim 1, wherein the control unit activates the REX earlier, when the fuel price is lower than the electricity price.

4. The method according to claim 1, wherein determining the fuel price and/or the electricity price includes querying a price database.

5. The method according to claim 1, further comprising:
controlling, by the control unit, thermal conditioning of the electric vehicle, wherein the thermal conditioning of the electric includes heating an interior of the electric vehicle and/or conditioning the HVB.

6. The method according to claim 1, wherein the activating of the REX is based on a current and/or predicted temperature of ambient air of the electric vehicle for the trip.

7. The method according to claim 6, further comprising:
providing, by an exterior sensor of the electric vehicle and/or a weather database, the current and/or predicted temperature to the control unit.

8. The method according to claim 1, wherein the activating of the REX is based on the predicted route of the electric vehicle for the trip.

9. A control unit for an electric vehicle, the control unit comprising:
a processor; and
a memory storing instructions that, when executed by the processor, cause the control unit to:
activate a range extender, REX, of the electric vehicle during a trip of the electric vehicle as a function of a determined current state of charge, SoC, of a high-voltage battery, HVB, of the electric vehicle, a determined current electrical energy demand of the electric vehicle and/or a predicted electrical energy demand of the electric vehicle for the trip, and a determined current thermal energy demand of the electric vehicle and/or a predicted thermal energy demand of the electric vehicle for the trip;
control charging of the HVB of the electric vehicle by an electric current provided by an electric generator of the REX;
control regulation of a temperature of the electric vehicle using waste heat of the REX provided by a heat exchanger of the REX; and
determine a fuel price of a fuel provided by a fueling station arranged along a predicted route of the electric vehicle and/or an electricity price of an electric charging current provided by a charging station arranged along the predicted route,
wherein the REX is activated based on the fuel price and/or the electricity price.

10. An electric vehicle, comprising:
a high-voltage battery, HVB;
a range extender, REX, that, in operation, charges the HVB during a trip of the electric vehicle; and
a control unit connected to the HVB and the REX wherein the control unit includes:
a processor; and
a memory storing instructions that, when executed by the processor, cause the control unit to:
activate the REX during the trip of the electric vehicle as a function of a determined current state of charge, SoC, of the HVB, a determined current electrical energy demand of the electric vehicle and/or a predicted electrical energy demand of the electric vehicle for the trip, and a determined current thermal energy demand of the electric vehicle and/or a predicted thermal energy demand of the electric vehicle for the trip;
control charging of the HVB of the electric vehicle by an electric current provided by an electric generator of the REX;
control regulation of a temperature of the electric vehicle using waste heat of the REX provided by a heat exchanger of the REX; and
determine a fuel price of a fuel provided by a fueling station arranged along a predicted route of the electric vehicle and/or an electricity price of an electric charging current provided by a charging station arranged along the predicted route,
wherein the REX is activated based on the fuel price and/or the electricity price.
